(19) United States
(12) Patent Application Publication
(10) Pub. No.: US 2012/0131011 A1
(43) Pub. Date: May 24, 2012

(54) INTELLIGENT QUERY ROUTING FOR FEDERATED PACS

(75) Inventors: Richard Vdovjak, Eindhoven (NL); Anca Ioana Daniela Bucur, Eindhoven (NL); Johan Gerhard Herman Reuzel, Eindhoven (NL)

(73) Assignee: KONINKLIJKE PHILIPS ELECTRONICS N.V., EINDHOVEN (NL)

(21) Appl. No.: 13/133,402

(22) PCT Filed: Nov. 19, 2009
(86) PCT No.: PCT/IB2009/055189

§ 371 Date: Jan. 16, 2012

Related U.S. Application Data
(60) Provisional application No. 61/138,330, filed on Dec. 17, 2008.

(51) Int. Cl. G06F 17/30

(52) U.S. Cl. 707/746; 707/741; 707/769; 707/E17.002; 707/E17.014

(57) ABSTRACT

A system having a plurality of local image storage elements storing patient images, each patient image being indexed by a local patient identifier, an identity storage element, located remotely from the local storage elements, storing a global patient identifier corresponding to each of a plurality of patients and one or more of the local patient identifiers corresponding to each of the plurality of patients and a location storage element, located remotely from the local image storage elements, storing an index of the patient images, the index including the local image storage element location of each image and the corresponding global patient identifier.

### BACKGROUND

Some of the largest hospitals in the United States are federated health care organizations comprising many autonomous hospital sites. Each autonomous hospital site will typically include its own facilities for conducting tests, studies, investigations, procedures, and etc. on patients and storing the results thereof, including patient images. One common system for storing such results is a Picture Archiving Communication System (“PACS”).

A federated health care organization may wish to integrate the PACS of its various hospital sites in order to provide data sharing across the entire organization or federation.

### SUMMARY OF THE INVENTION

A system having a plurality of local image storage elements storing patient images, each patient image being indexed by a local patient identifier, an identity storage element, located remotely from the local storage elements, storing a global patient identifier corresponding to each of a plurality of patients and one or more of the local patient identifiers corresponding to each of the plurality of patients and a location storage element, located remotely from the local image storage elements, storing an index of the patient images, the index including the local image storage element location of each image and the corresponding global patient identifier.

A method for storing a plurality of global patient identifiers and corresponding local patient identifiers for each of the global patient identifiers, storing an index of patient images including a storage location of each patient image and the corresponding global patient identifier, receiving a first query including one of the local patient identifiers, returning one of the global patient identifiers corresponding to the one of the local patient identifiers, receiving a second query including the one of the global patient identifiers and returning a listing of patient images corresponding to the one of the global patient identifiers, the listing including a storage location of each patient image, wherein the storage locations are remote from a location where the index is stored.

A method for sending a first query including a local patient identifier, receiving a response to the first query including a global patient identifier corresponding to the local patient identifier, sending a second query including the global patient identifier to an index of patient images and receiving a response to the second query including a listing of patient images corresponding to the global patient identifier, the listing including a storage location of each patient image, wherein the storage locations are remote from a location where the index is stored.

### BRIEF DESCRIPTION OF THE DRAWINGS

FIG. 1 shows an exemplary system for sharing medical information among locations of a federated health care system.

FIG. 2 shows an exemplary method for requesting and retrieving patient information from distributed databases within a federated health care system.

### DETAILED DESCRIPTION

The following exemplary embodiments may be further understood with reference to the following description and the appended drawings, wherein like elements are referred to with the same reference numerals. Described are exemplary systems and methods for integrating PACS from various hospital sites in different locations to form a federated PACS system that allows for data sharing among those various hospital sites.

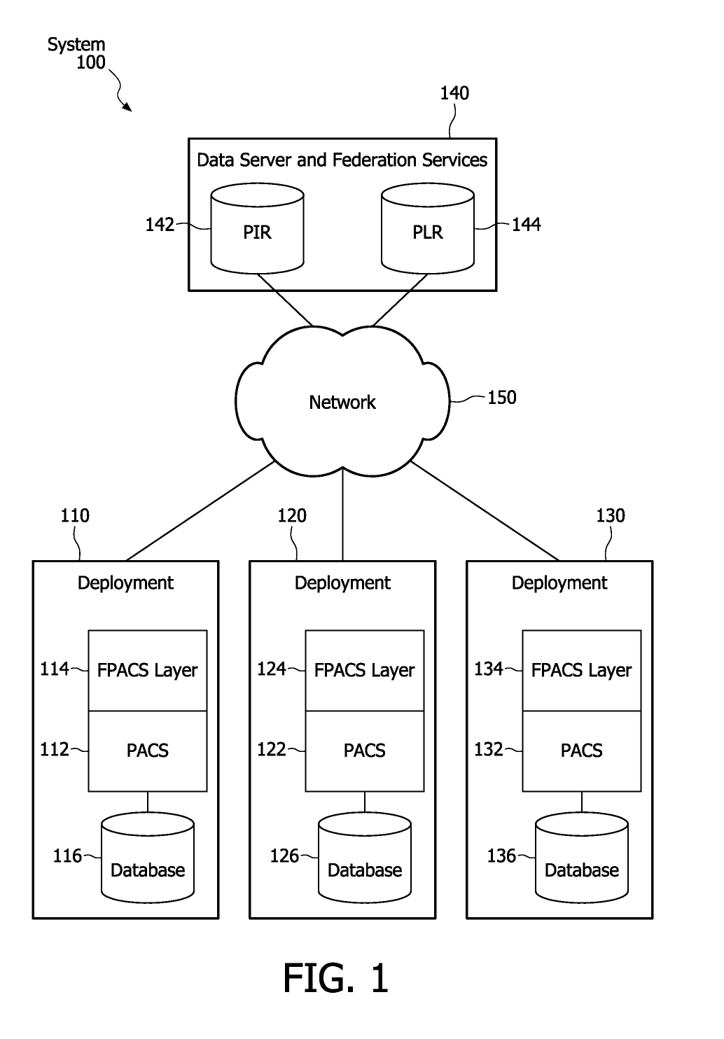

FIG. 1 illustrates an exemplary federated PACS (“FPACS”) system 100. The system 100 includes local FPACS deployments 110, 120 and 130 and a central FPACS data server and federation services 140 (hereinafter referred to as “data server 140”). The deployments 110, 120 and 130 and the data server 140 communicate by means of a network 150 (e.g., a WAN, the Internet, etc.). While FIG. 1 illustrates a system 100 with three local deployments, those having skill in the art will understand that this depiction is only exemplary and that other FPACS implementations may include tens or even hundreds of local deployments. Each of the deployments is typically located at a separate hospital site within a federated health care network, or at different departments within the same hospital. Communication among the local deployments 110, 120 and 130 and the data server 140 is conducted using one or a combination of protocols such as Health Level 7 (“HL7”) protocol, a Digital Imaging and Communications In Medicine (“DICOM”) protocol, and other protocols such as proprietary communications protocols.

The FPACS deployments 110, 120 and 130 each include PACS 112, 122 and 132. The PACS 112, 122 and 132 are typically pre-existing systems used to locally index patient images. Each PACS 112, 122 and 132 indexes patient images using a local patient identifier (e.g., social security number, insurance policy number, hospital patient ID, etc.) that may differ among the different PACS 112, 122 and 132. The deployments 110, 120 and 130 include local FPACS communication layers 114, 124 and 134. The communication layers 114, 124 and 134 route data queries between their corresponding local PACS 112, 122 and 132 and the network 150. The deployments 110, 120 and 130 also include image databases 116, 126 and 136 where patient images are stored.

The data server 140 includes a global patient identity registry (“PIR”) 142 (which is implemented, for example, by a cross-referencing (“PIX”) manager) and a global patient/study location registry (“PLR”) 144. The global PIR 142 integrates the various local patient identifiers used by the PACS 112, 122 and 132 into a global database. The global database defines each patient by a global patient identifier and links the global patient identifiers to the various local patient identifiers. Thus, a local FPACS deployment (e.g., the deployment 110) can query the global PIR 142 using the local patient identifier under which a patient is known by its corresponding PACS (e.g., PACS 112) and retrieve the global patient identifier for that patient.

The global PLR 144 stores, for each patient, all locations where there are images for that patient. Patients are identified in the global PLR 144 by the global patient identifiers as defined in the global PIR 142. The global PLR 144 is initially generated by aggregating data from each of the PACS 112, 122 and 132 at the time of generation. It may then be updated by adding a new record to the global PLR 144 when a new patient is registered at one of the PACS sites 112, 122 and 132; when this occurs, the global PIR 142 will also be queried to determine whether the patient is already known using an existing global patient identifier. This is usually achieved by comparing demographic data. By storing only location information for each patient (as opposed to a centralized data storage system containing patient images), the database size can be minimized. For example, for a federated health care network with ten locations attending one million patients, the solution can be implemented with a maximum database size of ten million rows in the extreme scenario where all patients have data at all locations, each row simply storing a patient global and/or local identifier and a location where there is data for the patient. As a rough estimate, this database could be implemented to have a maximum size of 50 megabytes.

The global PLR 144 can be modified to store a timestamp of the latest study performed at each institution. Thus, through such a modification, it would be possible for database queries to exclude hospital sites holding studies older than a certain threshold date, which can be predetermined, provided by the user, defined in the system based on the preferences of each institution, etc. A global PLR 144 storing timestamps only adds one extra field per database row (in order to store the timestamp), and thus does not result in a significant increase in database size over a more basic global PLR 144 that does not have the timestamp capability. An implementation of the PLR 144 that stores timestamps can be updated each time a new study is introduced into one of the PACS deployments 112, 122 and 132, or at a regular schedule with a predetermined frequency (daily, weekly, etc.).

The global PLR 144 can also be modified to further store relevant metadata with the patient records in addition to patient location information. Relevant metadata can be useful because the mere fact that a study is recent does not necessarily make it relevant; for example, a patient seeking care at an orthopedics clinic within a health care network may have entirely irrelevant, though recent, prior studies in an eye clinic. Thus, information from metadata about the nature of a study can be helpful. Relevant metadata may include one or more of a study ID, a body part, a modality and an exam code, or other possibilities not described here. The addition of metadata will result in an increase in the database of the global PLR 144, but the size will still be within the manageable size limits of a modern database management system. This type of global PLR 144 also allows for the generation of a timeline of relevant prior tests at one PACS deployment (e.g., PACS 112) without sending queries to the other PACS deployments (e.g., PACS 122 and 132). Tests can then be retrieved at the user's requests. As described above, location tables for this type of global PLR 144 can be updated with each new study or at desired regular intervals (e.g., at night in order to take advantage of lighter traffic on the network 150).

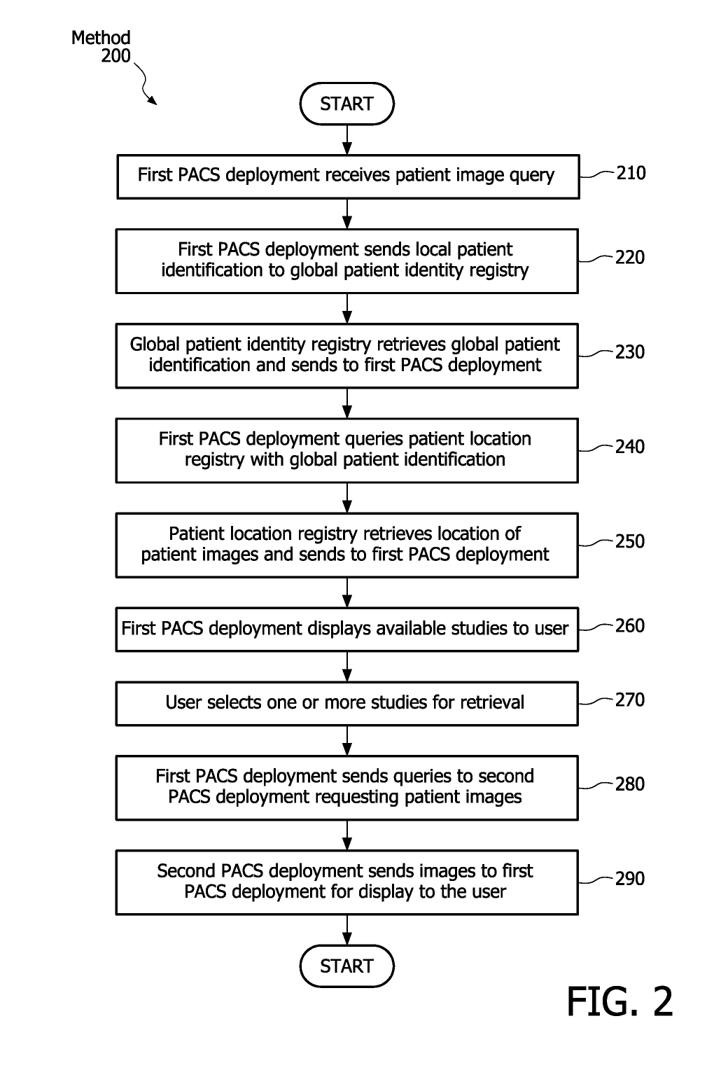

FIG. 2 shows an exemplary method 200 for routing a query for patient images. The method 200 is initiated, for example, by a user of one of the local PACS sites 112, 122 and 132 of FIG. 1; the description herein refers to a query initiated by a user of PACS deployment 112. In step 210, the PACS site 112 receives a query for patient information from a user (e.g., a doctor, a nurse, a testing technician, or other type of clinician, etc.). The query received in step 210 identifies the patient with a local patient identifier that is local to the PACS site 112, as described above. Depending on the type of global PLR 144 that is implemented with the system 100, the query may also include a timestamp cutoff point (for a global PLR 144 that stores timestamps) or a search criterion corresponding to the nature of the information that the user wishes to retrieve (for a global PLR 144 that stores full metadata).

In step 220, the PACS deployment 112 sends the query to the global PIR 142. The query is sent from the PACS deployment 112 to its FPACS communications layer 114, via the network 150, to the global PIR 142. As described above, transmission typically uses the HL7 protocol, though other methods and/or protocols are possible. In step 230, the global PIR 142 retrieves the global patient identifier, corresponding to the local patient identifier used in step 210, and returns it to the PACS deployment 112 in the same manner as step 220.

In step 240, the PACS deployment 112 generates a query and sends it to the global PLR 144. As above, transmission is accomplished via the FPACS communication layer 114 and the network 150. This second query identifies the patient by the global patient identifier received in step 230. For a basic implementation of the global PLR 144, solely the global patient identifier is required for this query. Alternately, for a global PLR 144 storing timestamp information, the query would include the global patient identifier and the desired timestamp cutoff submitted by the user in step 210. For a global PLR 144 storing full metadata information, the query would include the global patient identifier and the search criterion or criteria corresponding to the metadata as selected by the user in step 210.

In step 250, the global PLR 144 retrieves information and returns it to the PACS deployment 112. The information retrieved corresponds to the global patient identifier as retrieved in step 230 and transmitted in step 240, and provides the PACS deployment 112 with the locations of images for the patient. For example, the patient may have had images previously stored at the hospital sites corresponding to PACS deployments 122 and 132 (i.e., in databases 126 and 136). Locations are provided to the PACS 112 in the form of network addresses (e.g., IP addresses, network paths, etc.). In other implementations of the global PLR 144, added functionality is added to this retrieval. In a global PLR 144 implementation with timestamp records, only studies more recent than a certain threshold may be provided in response to the query; in a PLR implementation with full metadata records, only studies relevant to the search terms may be provided. For example, assume that the patient whose records are currently being searched at the location of the PACS deployment 112 was treated for a broken leg two years ago at the location of PACS deployment 122 and for glaucoma four years ago at the location of PACS deployment 132. A global PLR 144 that supports timestamp searching may return the location of the study in PACS deployment 122 (i.e., in database 126) if the search has specified a cut-off point of three years. However, if the patient is seeking treatment for an eye condition, a global PLR 144 that stores all relevant metadata may be searched with a query that returns the location of the study in PACS deployment 132 (i.e., in database 136), though it is less recent. Those having skill in the art will understand that a global PLR 144 that stores all metadata may also support the ability to search by timestamp.

In step 260, the results of the query sent in step 240 are provided to the user of the PACS deployment 112. For a basic global PLR 144, the results are simply a list of locations (e.g., for the example described above, the user would be informed that the patient has one previous study in the database 126 and one in the database 136). For a timestamp global PLR 144, the list would be provided with locations and corresponding timestamps (e.g., for the example described above, the user would be informed that the patient has a previous study stored in database 126, together with the date that study occurred; as described above, the study stored in database 136 would not be returned because it is beyond the specified time threshold). For a full metadata global PLR 144, the provided list would include locations, timestamps, and any other metadata corresponding to the records retrieved from the global PLR 144 (e.g., for the example described above, the user would be informed of the prior treatment for glaucoma and its corresponding images stored at the location of PACS deployment 132; the prior study undertaken at the location of PACS deployment 122 would not be returned because it is not relevant to the search the user is performing.)

In step 270, the user of PACS deployment 112 selects one or more studies from those provided in step 260 for retrieval. This selection may be accomplished by selecting studies from a list (e.g., with a mouse), selecting a “retrieve all” command, or any other process known in the art. In step 280, the request is sent by the FPACS communication layer 114, via the network 150, to the location where images are stored. For example, if the images to be retrieved are located in database 126, the request would be passed from FPACS communication layer 114, through the network 150, to the FPACS communication layer 124, the PACS 122, and the database 126. This request is not transmitted to or through the global PLR 144. In step 290, the requested images are transmitted from their storage location (e.g., database 126) to the requesting user, via the same data path, and displayed to the user. All identified relevant images can be retrieved (pre-fetched) at this step, or only the metadata required to build a timeline, in which case the images are retrieved when a study is selected from the timeline. Those having skill in the art will understand that display to the user may include the option to print images, present a timeline of studies with selection options, retrieve all images, etc. Following step 290, the method 200 terminates. Those having skill in the art will understand that the method 200 may terminate prior to this step if, at any point, no results are returned in response to a database query.

By storing images locally at various PACS sites while storing an index at a central location, a very efficient data sharing system can be provided. This type of system is scalable to large systems including tens or hundreds of hospitals and allows a physician at any participating hospital to retrieve images located at any other hospital within the system.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

It is also noted that the claims may include reference signs/numerals in accordance with PCT Rule 6.2(b). However, the present claims should not be considered to be limited to the exemplary embodiments corresponding to the reference signs/numerals.

What is claimed is:

1. A system, comprising:
a plurality of local image storage elements (112, 122, 132) storing patient images, each patient image being indexed by a local patient identifier;
an identity storage element (142), located remotely from the local storage elements (112, 122, 132), storing a global patient identifier corresponding to each of a plurality of patients and one or more of the local patient identifiers corresponding to each of the plurality of patients; and
a location storage element (144), located remotely from the local image storage elements (112, 122, 132), storing an index of the patient images, the index including the local image storage element location of each image and the corresponding global patient identifier.

2. The system of claim 1, wherein the identity storage element (142) receives a query including one of the local patient identifiers and returns a corresponding one of the global patient identifiers.

3. The system of claim 1, wherein the location storage element (144) receives a further query including the returned one of the global patient identifiers and returns a listing of patient images of the patient identified by the returned one of the global patient identifiers, the listing including the local storage element (112, 122, 132) location of each patient image.

4. The system of claim 3, wherein the index further includes time stamps, the further query including a time delimiter and the listing including only the patient images matching the time delimiter and the local storage element (112, 122, 132) locations of the patient images matching the time delimiter.

5. The system of claim 3, wherein the index further includes metadata, the further query including a metadata delimiter and the listing including only the patient images matching the metadata delimiter.

6. The system of claim 5, wherein the metadata includes one of a study ID, a body part, a modality, an image type and an exam code.

7. The system of claim 3, wherein the query and the further query are generated by one of the local image storage elements (112, 122, 132).

8. The system of claim 7, wherein the one of the local image storage elements (112, 122, 132) displays the listing to a user.

9. The system of claim 7, wherein the one of the local image storage elements (112, 122, 132) retrieves one of the patient images in the listing from a further one of the local storage elements (112, 122, 132) storing the one of the patient images.

10. The system of claim 1, wherein the storage elements communicate using one of an HL7 protocol, a DICOM protocol and a proprietary protocol.

11. A method, comprising:
storing a plurality of global patient identifiers and corresponding local patient identifiers for each of the global patient identifiers;
storing an index of patient images including a storage location (112, 122, 132) of each patient image and the corresponding global patient identifier;
receiving (220) a first query including one of the local patient identifiers;
returning (230) one of the global patient identifiers corresponding to the one of the local patient identifiers;
receiving (240) a second query including the one of the global patient identifiers; and
returning (250) a listing of patient images corresponding to the one of the global patient identifiers, the listing including the storage location (112, 122, 132) of each patient image, wherein the storage locations (112, 122, 132) are remote from a location (142) where the index is stored.

12. The method of claim 11, wherein the index further includes time stamps, the second query including a time delimiter and the listing including only the patient images matching the time delimiter.

13. The method of claim 11, wherein the index further includes metadata, the second query including a metadata delimiter and the listing including only the patient images matching the metadata delimiter.

14. The method of claim 11, further comprising:
generating a time line based on the listing.

15. The method of claim 11, wherein the first and second queries are generated by one of the patient image storage locations (112, 122, 132).

16. A method, comprising:
sending (220) a first query including a local patient identifier;
receiving (230) a response to the first query including a global patient identifier corresponding to the local patient identifier;
sending (240) a second query including the global patient identifier to an index of patient images;
receiving (250) a response to the second query including a listing of patient images corresponding to the global patient identifier, the listing including a storage location (112, 122, 132) of each patient image, wherein the storage locations (112, 122, 132) are remote from a location where the index (142) is stored.

17. The method of claim 16, wherein the first and second queries are sent by one of the storage locations (112, 122, 132).

18. The method of claim 16, further comprising:
sending (280) a third query to the one of the storage locations (112, 122, 132) corresponding to one of the patient images in the listing; and
receiving (290) a response to the third query including the one of the patient images.

19. The method of claim 16, wherein the index further includes time stamps, the second query including a time delimiter and the listing including only the patient images matching the time delimiter.

20. The method of claim 16, wherein the index further includes metadata, the second query including a metadata delimiter and the listing including only the patient images matching the metadata delimiter.
